(19) United States
(12) Patent Application Publication
(10) Pub. No.: US 2003/0169141 A1
(43) Pub. Date: Sep. 11, 2003

(54) Ignition coil with insulating resin

(76) Inventors: Takashi Nagata, Okazaki-city (JP); Kazutoyo Osuka, Gamagori-city (JP)

Correspondence Address: NIXON & VANDERHYE, PC, 1100 N GLEBE ROAD, 8TH FLOOR, ARLINGTON, VA, 22201-4714, US

(21) Appl. No.: 10/383,686

(22) Filed: Mar. 10, 2003

(30) Foreign Application Priority Data
Mar. 11, 2002 (JP) 2002-65509

(51) Int. Cl. H01F 27/02

(52) U.S. Cl. 336/96

(57) ABSTRACT

An ignition coil includes an insulating resin, a primary coil, and a secondary coil. The primary coil is formed by winding a primary wire coated with a primary coating, and is disposed in the insulating resin. The secondary coil is formed by winding a secondary wire coated with a secondary coating, and is disposed in the insulating resin to be concentric with the primary coil. A glass transition temperature of the insulating resin is set to 130° C. or below, and a glass transition temperature of the secondary coating is set to 150° C. or above. Therefore, thermal stress between the insulating resin and parts adhered to the insulating resin in the ignition coil can be effectively reduced, and the life of the ignition coil with cooling/heating cycle can be elongated.

### CROSS REFERENCE TO RELATED APPLICATION

This application relates to and incorporates herein by reference Japanese Patent Application No. 2002-65509 filed on Mar. 11, 2002.

### FIELD OF THE INVENTION

The present invention relates to a stick type ignition coil with an insulating resin, which is inserted in a spark plug hole of a cylinder in an engine, for example.

### BACKGROUND OF THE INVENTION

An ignition coil includes a primary coil disposed on low voltage side and a secondary coil disposed on high voltage side. The primary coil is composed of a primary winding covered with a primary coating. Similarly, the secondary coil is composed of a secondary winding covered with a secondary coating. Generally, the ignition coil is inserted in a spark plug hole of a cylinder of an engine. The secondary coil is disposed on a peripheral surface of a secondary spool, and secondary winding of the secondary coil is wound around an outer core. The secondary coil and the secondary spool are accommodated in a casing, and are embedded with an insulating resin filled in the casing. The insulating resin insulates plural parts of the ignition coil from each other, and fixes the parts in the casing.

Generally, physical properties of the insulating resin are extremely changed at a glass transition temperature (hereinafter, referred to as Tg). For example, an insulating property of the insulating resin is extremely changed at the Tg, as shown in FIG. 1. In FIG. 1, a horizontal axis represents temperature and a vertical axis represents an insulation resistance of the insulating resin. The insulation resistance of the insulating resin is suddenly changed at the Tg. When the temperature of the insulating resin is below the Tg, the insulation resistance is high and the insulating property is excellent. But, when the temperature of the insulating resin is above the Tg, the insulation resistance is low and the insulating property deteriorates.

Because the ignition coil is inserted in the spark plug hole of the cylinder of the engine, the temperature of the insulating resin is affected by the operation state of the engine. Therefore, after the engine stops and a sufficient time has elapsed, the insulating resin is cooled down to a lowest temperature (hereinafter, referred to as TL). Also, after the engine starts and a sufficient time has elapsed, the insulating resin is heated up to a highest temperature (i.e., hereinafter, referred to as TH). Here, a usage environmental temperature (ΔT) of the insulating resin is in a range between the TL and the TH. In a case where the Tg is set higher than the TH, the insulating resin has an excellent insulating property in the entire range ΔT between the TL and the TH. Therefore, generally, the Tg of the insulating resin is set higher than the TH.

However, when the Tg of the insulating resin is set higher than the TH, the insulating resin is used at a temperature below the Tg, and Young's modulus of the insulating resin is relatively large, as shown in FIG. 2. In FIG. 2, a horizontal axis represents temperature and a vertical axis represents the Young's modulus of the insulating resin. The Young's modulus of the insulating resin is suddenly changed at the Tg. When the temperature of the insulating resin is below the Tg, the Young's modulus is large. But, when the temperature of the insulating resin is above the Tg, the Young's modulus is small. Therefore, when the Tg is set higher than the TH, the Young's modulus of the insulating resin is relatively large in the entire range ΔT between the TH and the TL, and the insulating resin becomes hard.

Generally, the ignition coil is used under the usage environment of cooling and heating cycle (i.e., cooling/heating cycle). During the cooling/heating cycle, a relatively large thermal stress appears between the insulating resin and parts adhered to the insulating resin, because the coefficient of thermal expansion of the insulating resin is different form the coefficient of thermal expansion of the parts adhered to the insulating resin, respectively. In detail, the insulating resin is much hardened, compared with the parts adhered to the insulating resin. This large thermal stress decreases the life of the ignition coil with the cooling/heating cycle.

### SUMMARY OF THE INVENTION

The present invention has an object to reduce a thermal stress among an insulating resin and parts adhered to the insulating resin in an ignition coil, so that the life of the ignition coil with a cooling/heating cycle increases.

In the present invention, an ignition coil includes an insulating resin, a primary coil and a secondary coil. The primary coil is formed by winding a primary wire coated with a primary coating, and is disposed in the insulating resin. The secondary coil is formed by winding a secondary wire coated with a secondary coating, and is disposed in the insulating resin. Further, the secondary coil is disposed to be concentric with the primary coil. In the ignition coil, a glass transition temperature of the insulating resin is set equal to 130° C. or below. Because the Tg of the insulating resin is set lower, the Tg may be lower than the highest temperature TH of a using environment temperature. Therefore, thermal stress between the insulating resin and the components around the insulating resin of the ignition coil is not caused in a temperature range between the Tg and the highest temperature TH, but is caused only in a temperature range between the lowest temperature TL and the Tg. Accordingly, the thermal stress caused in the ignition coil can be effectively restricted, and the life of the ignition coil with the cooling and heating cycle can be increased. Further, because the Tg of the insulating resin is set lower, the material for the insulating resin can be readily selected in a low cost. Therefore, product cost of the ignition coil can be effectively reduced.

Preferably, the Tg of the insulating resin is set in a range between 90° C. and 130° C. In this case, a difference between the highest temperature TH and the Tg can be readily adjusted in a suitable range, and the thermal stress caused in the ignition coil can be more effectively restricted.

On the other hand, a glass transition temperature Tg of the secondary coating is set equal to 150° C. or above. In this case, even when the insulating performance of the insulating resin is decreased in the using environment temperature higher than the Tg of the insulating resin, insulating performance between the secondary windings and between the primary winding and the secondary winding can be obtained by the secondary coating. Thus, the insulating performance of the ignition coil can be improved while the ignition coil can be used in a long time.

Preferably, the Tg of the secondary coating is in a range between 150° C. and 210° C. When the Tg of the secondary coating is higher than 210° C., the product cost of the secondary coating is greatly increased. Accordingly, by setting the Tg of the secondary coating in the range between 150° C. and 210° C., the product cost of the ignition coil can be effectively restricted while the insulation performance of the ignition coil is improved.

### BRIEF DESCRIPTION OF THE DRAWINGS

The above and other objects, features and advantages of the present invention will become more apparent from the following detailed description made with reference to the accompanying drawings. In the drawings:

FIG. 1 is a graph showing a relation between temperature and insulation resistance of an insulating resin;

FIG. 2 is a graph showing a relation between temperature and Young's modulus of an insulating resin;

FIG. 3 is a graph showing a temperature range in which thermal stress is caused;

FIG. 4 is a cross-sectional view showing an ignition coil taken along an axial direction according to an embodiment of the present invention;

FIG. 5 is an enlarged cross-sectional view showing a secondary coil and parts around secondary coil in the ignition coil according to the embodiment;

FIG. 6 is a graph showing a result of cooling/heating cycle test; and

FIG. 7 is a graph showing a result of high voltage generating test.

### DETAILED DESCRIPTION OF THE PREFERRED EMBODIMENT

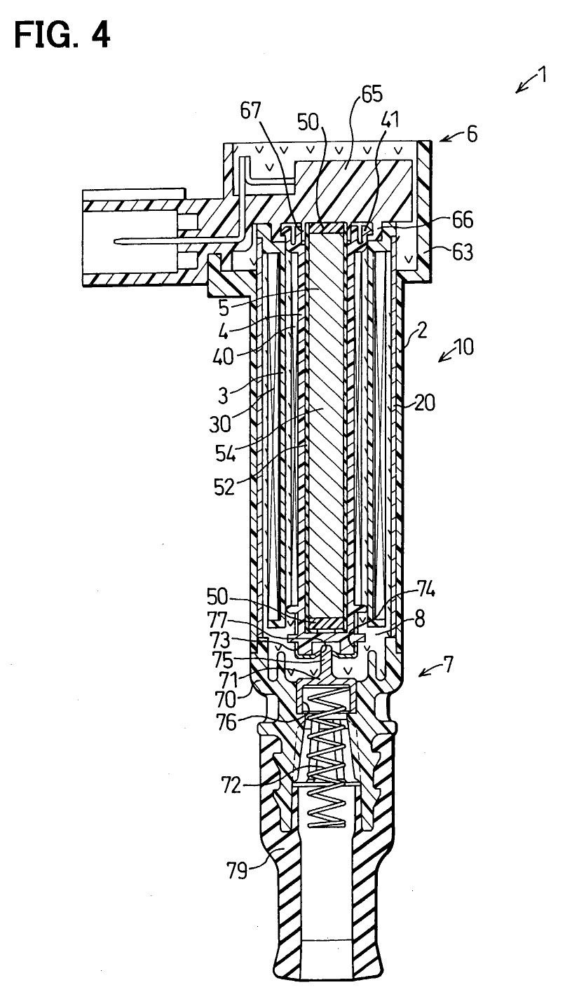

An embodiment of the present invention will be described with the accompanying drawings. An ignition coil 1 is inserted in a spark plug hole of each cylinder in an engine block, and is connected with an ignition plug at a lower side of the ignition coil 1, as shown in FIG. 4. The ignition coil 1 includes a connector 6, a coil unit 10, and a high voltage tower 7. The coil unit 10 is provided with a casing 2, which has a cylindrical shape. A center core 5, a secondary spool 4, a secondary coil 40, a primary spool 3, a primary coil 30, and an outer core 20 are accommodated from center to outside in the casing 2, in this order.

The center core 5 is composed of a center core portion 54, an elastic part 50, and a rubber tube 52. The center core portion 54 is formed by stacking a plurality of silicon steel plates along a radial direction, and has a rod shape. The silicon steels have oblong-card shapes and have different length. The elastic part 50 is made of silicon rubber, and has a column shape. Two elastic parts 50 are disposed on top and bottom ends of the center core portion 54. The rubber tube 52 has a cylindrical shape, and is disposed to cover the center core portion 54 and the two elastic parts 50.

The secondary spool 4 has a cylindrical shape with a bottom, and is made of resin. The secondary spool 4 is disposed outside of the center core 5, and is concentric with the center core 5. A spool-side engagement claw 41 is disposed on the top end of the secondary spool 4, and extends upward. As shown in FIG. 5, the secondary coil 40 has a cylindrical shape, and is formed by winding a secondary winding 400 with about 17,000 turns. Further, the secondary winding 400 is coated with a secondary coating 401. A diameter of a wire of the secondary winding 400 with the secondary coating 401 is about 65 μm, and the outer diameter of the entire secondary coil 40 is about 14 mm.

The primary spool 3 is disposed outside of the secondary spool 4, and is concentric with the secondary spool 4. The primary coil 30 is disposed outside of the primary spool 3, and is formed by winding a primary winding (not shown). The primary coil 30 is also coated with a primary coating (not shown). The outer core 20 is disposed outside of the primary coil 30, and has a cylindrical shape with a slit that extends in an axial direction.

An epoxy resin 8 is disposed among the above-mentioned parts accommodated in the casing 2. For example, the epoxy resin 8 is provided among the secondary windings 400 or between the secondary winding 400 and the secondary spool 4, so that each wire of the secondary windings 400 is insulated by the epoxy resin 8. The epoxy resin 8 is an insulating resin in the present invention.

The connector 6 is disposed upside of the coil unit 10, and is composed of a connector housing 63 and a connector terminal 65. The connector housing 63 is integrally formed with the casing 2, and composes a broad radial portion in the present invention. The connector terminal 65 is made of resin, and has a rectangular shape. The connector terminal 65 is accommodated in the connector housing 63. A terminal-side engagement claw 66 is disposed under the connector terminal 65, and extends downward. The terminal-side engagement claw 66 and the spool-side engagement claw 41 are connected together, so that the connector terminal 65 connects to the secondary spool 4. A ring rib 67 is disposed under the connector terminal 65, and extends downward. The ring rib 67 is disposed between the center core 5 and the top end of the secondary spool 4, so that the secondary spool 4 and the center core 5 are mutually positioned.

The high voltage tower 7 is disposed under the coil unit 10, and is composed of a high voltage tower housing 70, a high voltage terminal 71, a spring 72, a high voltage bowl 73, and a plug holder 79. The tower housing 70 is made of resin, and has a cylindrical shape. The high voltage terminal 71 is disposed in the tower housing 70, and has a teacup shape with an opening 76 opened downward. A convex part 75 is disposed on the top of the high voltage terminal 71, and has a rod shape protruded upward. The high voltage bowl 73 is disposed upside of the convex part 75, and has a teacup shape. The high voltage bowl 73 has an opening 74 opened upward. The secondary spool 4 is inserted in the opening 74 of the high voltage bowl 73. The high voltage bowl 73 electrically connects to the secondary coil 40. An engagement hole 77 is opened in the bottom of the high voltage bowl 73. The convex part 75 is inserted from the interlocking hole 77 into the high voltage bowl 73, so that the secondary coil 40 and the high voltage terminal 71 are electrically connected to each other. The spring 72 has a helical shape. The top end of the spring 72 is inserted in the opening 76 of the high voltage terminal 71, and the bottom end of the spring 72 is inserted to the ignition plug (not shown). The ignition plug is held with a plug holder 79, which is disposed downside of the high voltage tower housing 70 and is made of rubber.

The ignition coil 1 operates as follows. A control signal is sent from the connector terminal 65 to the primary coil 30. The control signal generates a high voltage in the secondary coil 40 by mutual induction. The high voltage in the secondary coil 40 is sent to the ignition plug through the high voltage terminal 71 and the spring 72. The high voltage in the ignition plug makes an electric spark in a gap of the ignition plug.

The ignition coil 1 is manufactured as follows. The manufacturing method of the ignition coil 1 includes an assembling process and an injection process of the epoxy resin 8. In the assembling process, the high voltage tower 7 is assembled at first. In detail, the lower side of the tower housing 70 is press-inserted in the plug holder 79. Then, the high voltage terminal 71, the spring 72, and the like are assembled in the high voltage tower housing 70. Next, the casing 2 is assembled on the tower housing 70. Then, the outer core 20, the center core 5, the primary spool 3, the secondary spool 4, and the like are assembled in the casing 2. The connector terminal 65 is assembled in the connector housing 63 integrated with the casing 2. In this case, the ring rib 67 is inserted between the center core 5 and the secondary spool 4, and also the terminal-side engagement claw 66 and the spool-side engagement claw 41 are connected together. In this way, the ignition coil 1 is temporarily assembled.

In the epoxy resin injection process, the epoxy resin 8 is prepared at first. The temporary assembled ignition coil 1 is placed in a vacuum chamber, and the vacuum chamber is pumped to be vacuum. Then, the epoxy resin 8 is injected into an opening of the connector housing 63 of the temporary assembled ignition coil 1 placed in the vacuum chamber, so that the temporary assembled ignition coil 1 is filled with the epoxy resin 8. After that, the ignition coil 1 is heated at a predetermined temperature so that the epoxy resin 8 is hardened. As a result, the ignition coil 1 is accomplished.

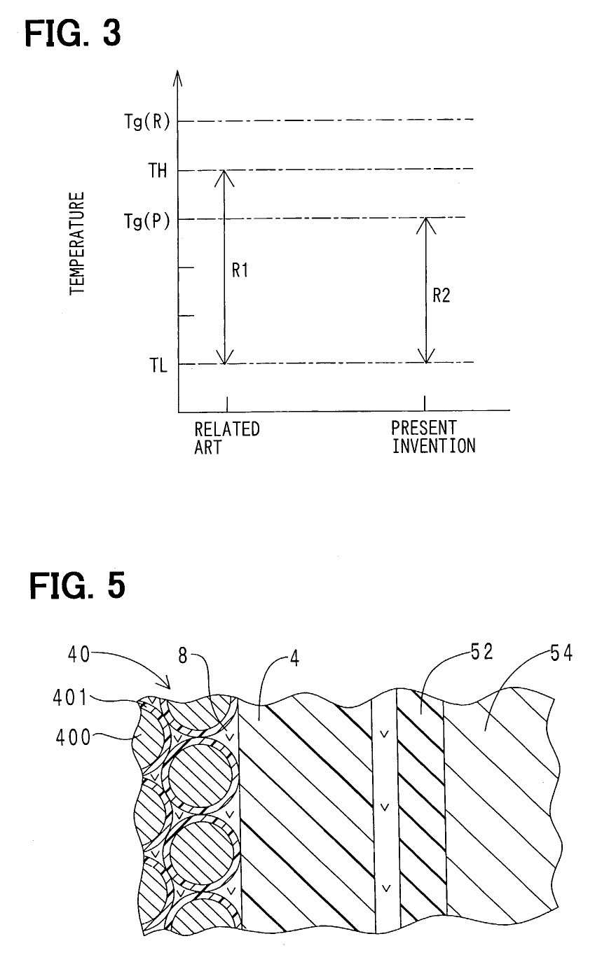

In this embodiment of the present invention, the glass transition temperature (i.e., Tg) of the above epoxy resin 8 used as an insulating resin is set equal to or below 130° C. In the embodiment, the ignition coil 1 is inserted in the spark plug hole. Therefore, during an engine operation, ambient temperature around the ignition coil 1 may be above 130° C., in other words, the using temperature TH may be above 130° C. Thus, when the Tg of the insulating resin is set equal to or below 130° C., the Tg is generally equal to or below the TH. When the ignition coil 1 is used above the Tg, Young's modulus of the insulating resin is suddenly reduced as shown in FIG. 2, and the insulating resin is softened and deformable. Therefore, a thermal stress between the insulating resin and parts adhered to the insulating resin in the ignition coil 1 is effectively relieved by the deformation of the insulating resin.

The above consideration is shown in FIG. 3, schematically. In FIG. 3, the Tg(R) represents a glass transition temperature of an insulating resin in a related art, and the Tg(P) represents a glass transition temperature of the insulating resin in the present invention. The temperature range, in which the thermal stress arises among the insulating resin and the parts adhered to the insulating resin, is shown by R1 and R2 in FIG. 3. In the temperature range between the Tg(P) and the TH, the thermal stress in the present invention is not generally caused, because the thermal stress is relieved at a temperature above the Tg(P). Therefore, the temperature range, in which the thermal stress is generated in the present invention, becomes narrower than that in the related art. As a result, the life of the ignition coil 1 in the present invention is longer than that in the related art. Moreover, in the ignition coil 1 of the present invention, a resin material such as multipurpose resin material, used commercially and widely, can be used instead of the epoxy resin 8. In this case, a manufacturing cost of the ignition coil 1 in the present invention can be effectively reduced.

In general, the Tg of the insulating resin is controlled by a selection of a setting material (i.e., hardening agent) or a mixing ratio of the setting material. For example, in a case where the insulating resin is composed of an epoxy resin, when tetrahydro-phthalic-anhydride (i.e., the THPA) is used as the setting material, instead of hexa-hydro-phthalic-anhydride (i.e., HHPA), the Tg of the insulating resin readily decreases. Further, the Tg of the insulating resin can be controlled by the mixing ratio of the THPA in the epoxy resin.

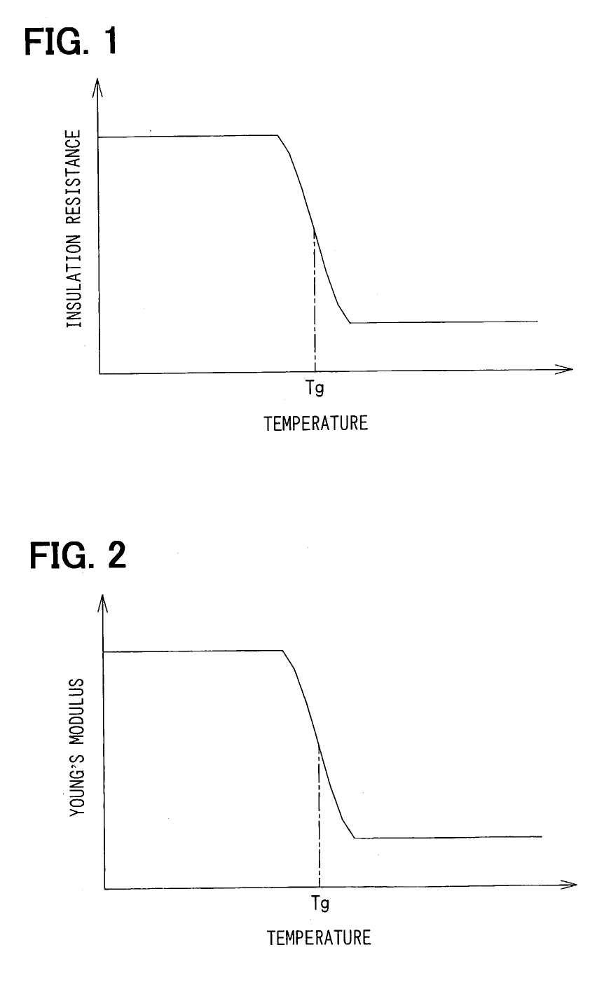

In the present invention, it is preferred that the Tg of the insulating resin (e.g., epoxy resin 8) is in the range between 90° C. and 130° C. As shown in FIG. 1, when the usage environmental temperature of the insulating resin is above the Tg, the insulating property of the insulating resin deteriorates. Therefore, when the Tg of the insulating resin is below 90° C., a temperature range between the Tg and the TH is relatively wide, so that the insulating property of the insulating resin deteriorates in this temperature range. In this case, the ignition coil 1 may be damaged quickly, and a predetermined high-voltage may be not applied to the ignition coil 1.

Further, when the Tg of the insulating resin (e.g., epoxy resin 8) is in a range between 115° C. and 130° C., the engine with the ignition coil 1 is suitably used, for example, in the tropics. Because the TH is generally high in the tropics, the temperature range between the Tg and the TH is relatively wide when the Tg of the insulating resin is set low. If the Tg is set low, the temperature range between the Tg and the TH of the insulating resin is wide and the insulating property of the insulating resin deteriorates in wide temperature range. Accordingly, in this case, by setting the Tg of the insulating resin in the range between 115° C. and 130° C., the life of the ignition coil 1 can be elongated.

When the Tg of the insulating resin is in a range between 105° C. and 115° C., the engine with the ignition coil 1 can be suitably used, for example, in a warm temperate zone. In this case, because the TH is in a middle temperature range and is not so high, when the Tg of the insulating resin is set in the range between 105° C. and 115° C., the temperature range between the Tg and the TH higher than the Tg can be made suitable, and the ignition coil 1 can be suitably used for an engine for the warm temperature zone.

When the Tg of the insulating resin is in a range between 90° C. and 105° C., the engine with the ignition coil 1 can be suitably used, for example, in the cold latitudes. Because the TH is low in the cold latitudes, when the Tg is set in the range between 90° C. and 105° C., the temperature range between the Tg and the TH can be made suitable, and the ignition coil 1 can be suitably used for an engine for the cold latitudes.

Moreover, it is preferred that the Tg of the above-mentioned secondary coating 401 is equal to or above 150° C. When the Tg of the insulating resin is equal to or below 130° C., the Tg of the insulating resin is generally below the TH. When the ignition coil is used above the Tg of the insulating resin, the Young's modulus of the insulating resin is suddenly reduced, and the insulating resin is softened and is deformable. Therefore, a thermal stress among the insulating resin and the parts adhered to the insulating resin can be absorbed and released by the deformation of the insulating resin, so that the life of the ignition coil 1 with the cooling/heating cycle increases. However, when the usage environmental temperature of the insulating resin is above the Tg of the insulating resin, the insulating property of the insulating resin conversely deteriorates. To compensate this deterioration of the insulating property, the Tg of the secondary coating 401 is set equal to or higher than 150° C. so that the insulating property among the secondary winding 400 and between the secondary winding 400 and the primary winding may be improved.

The Tg of the secondary coating 401 is controlled by a selection of a material or a mixing ratio of the plural materials. For example, in a case where the secondary coating 401 has polyurethane and polyimide, when the mixing ratio of polyimide in the secondary coating 401 increases, the Tg of the secondary coating 401 increases.

Further, it is preferred that the Tg of the secondary coating 401 is set in a range between 150° C. and 210° C. If the Tg of the secondary coating is above 210° C., manufacturing cost of the secondary coating 401 is higher, and melting temperature of a copper coating, which composes the secondary coating, is relatively high so that soldering for connecting the secondary coil 401 may be deteriorated.

Furthermore, when the Tg of the secondary coating 401 is set in a range between 150° C. and 170° C., it is preferred that demanding voltage (i.e., target voltage) of the ignition plug in an engine is low.

Further, when the Tg of the secondary coating 401 is in the range between 150° C. and 170° C., and when the Tg of the insulating resin is in the range between 115° C. and 130° C., the engine with the ignition coil 1 is suitably used, for example, in a case where the TH is relatively high and the demanding voltage of the ignition plug in the engine is low.

When the Tg of the secondary coating 401 is in the range between 150° C. and 170° C. and the Tg of the insulating resin is in the range between the 105° C. and 115° C., the engine with the ignition coil 1 is suitably used, for example, in a case where the TH is in an intermediate temperature range and the demanding voltage of the ignition plug in the engine is low.

When the Tg of the secondary coating 401 is in the range between 150° C. and 170° C. and the Tg of the insulating resin is in the range between 90° C. and 105° C., the engine with the ignition coil 1 is suitably used, for example, in a case where the TH is relatively low and the demanding voltage of the ignition plug in the engine is low.

Furthermore, when the Tg of the secondary coating 401 is in a range between 170° C. and 190° C., the ignition coil 1 can be used for an engine where the demanding voltage of the ignition plug is in an intermediate degree.

When the Tg of the secondary coating 401 is in the range between 170° C. and 190° C. and when the Tg of the insulating resin is in the range between 115° C. and 130° C., the engine with the ignition coil 1 is suitably used, for example, in a case where the TH is relatively high and the demanding voltage of the ignition plug in the engine is in the intermediate degree.

When the Tg of the secondary coating 401 is in the range between 170° C. and 190° C. and when the Tg of the insulating resin is in the range between 105° C. and 115° C., the engine with the ignition coil 1 is suitably used, for example, in a case where the TH is in a middle temperature range and the demanding voltage of the ignition plug in the engine is in the intermediate degree.

When the Tg of the secondary coating 401 is in the range between 170° C. and 190° C. and when the Tg of the insulating resin is in the range between 90° C. and 105° C., the engine with the ignition coil 1 is suitably used, for example, in a case where the TH is relatively low and the demanding voltage of the ignition plug in the engine is in the intermediate degree.

Furthermore, in a case where the Tg of the secondary coating 401 is in the range between 190° C. and 210° C., it is preferred that demanding voltage of the ignition plug in an engine is high, because the temperature range above the Tg of the secondary coating 401 and the TH is relatively narrow.

When the Tg of the secondary coating 401 is in the range between 190° C. and 210° C. and the Tg of the insulating resin is in the range between 115° C. and 130° C., the engine with the ignition coil is suitably used, for example, in a case where the TH is relatively high and the demanding voltage of the ignition plug in the engine is high.

When the Tg of the secondary coating is in the range between 190° C. and 210° C. and the Tg of the insulating resin is in the range between 105° C. and 115° C., the engine with the ignition coil 1 is suitably used, for example, in a case where the TH is in a middle temperature range and the demanding voltage of the ignition plug in the engine is high.

When the Tg of the secondary coating 401 is in the range between 190° C. and 210° C. and the Tg of the insulating resin is in the range between 90° C. and 105° C., the engine with the ignition coil 1 is suitably used, for example, in a case where the TH is relatively low and the demanding voltage of the ignition plug in the engine is high.

Next, experiments of the above-mentioned ignition coil 1 performed by the inventors of the prevent invention will be now described. The epoxy resin 8 used as an insulating resin of the ignition coil 1 has following characteristics. The epoxy resin 8 is made of epoxy pre-polymer and the THPA. The epoxy pre-polymer is a base material, and the THPA is a setting material mixed into the base material so that the base material is hardened. When the mixing ratio of the THPA in the epoxy pre-polymer increases, the Tg of the epoxy resin 8 decreases. In this example, the Tg of the epoxy resin 8 is 100° C., and the TH is 130° C. Here, the Tg of the epoxy resin 8 and the Tg of the secondary coating 401 are measured by thermo mechanical analysis method (i.e., TMA method, which is determined in Japan Industrial Standard K 7197), and TMA method is performed by TMA 8140C of TAS-200 system manufactured by Rigaku Denki Co. Ltd. When the usage environmental temperature is in the range between 100° C. and 130° C., the thermal stress does not substantially arise among the epoxy resin 8 and the parts adhered to the epoxy resin 8 such as the secondary coating 401, because the thermal stress is relieved by the deformation of the epoxy resin 8 in the temperature range. Accordingly, the life of the ignition coil 1 with cooling/heating cycle is increased.

The secondary coating 401 includes polyurethane and polyimide. When the mixing ratio of polyimide to the secondary coating 401 increases, the Tg of the secondary coating 401 increases. For example, when the Tg of the secondary coating 401 is 195° C., the Tg of the secondary coating 401 is higher than the TH, and the insulating property among the secondary winding 400 and the insulating property between the secondary winding 400 and the primary winding can be effectively improved.

The ignition coils of an example of the embodiment and a comparison example are compared in a cooling/heating cycle test and a high-voltage generating test. In the example of the embodiment, the Tg of the epoxy resin 8 is 100° C., and the Tg of the secondary coating 401 is 195° C. On the other hand, in the comparison example, the Tg of the epoxy resin 8 is 135° C., and the Tg of the secondary coating 401 is 195° C.

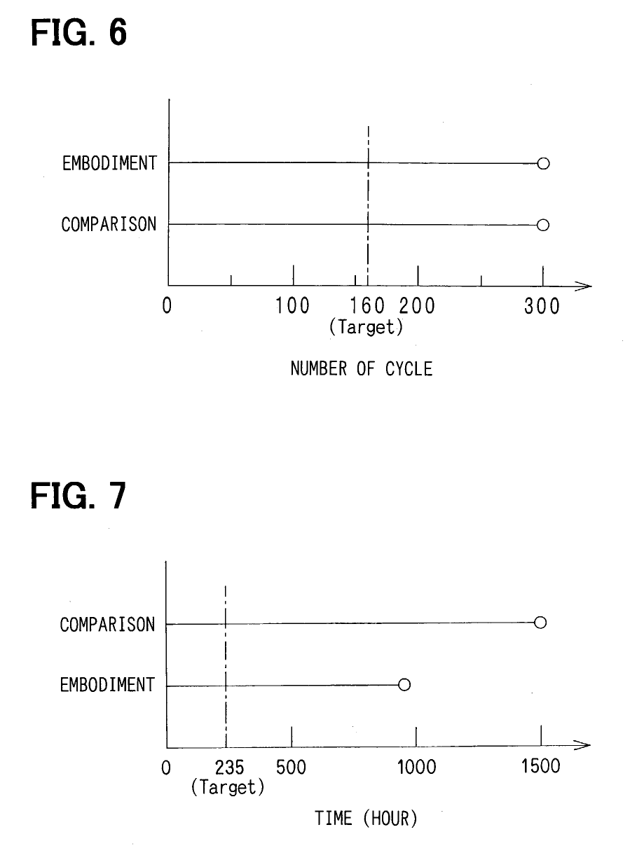

The heating/cooling cycle test is performed by means of heating and cooling the ignition coil repeatedly. In the heating/cooling cycle test, the TL is set to −30° C. and the TH is set to 130° C. in each cycle. Therefore, the difference ΔT between the TH and the TL is 160° C. And the number of cooling/heating cycles are 300 cycles, and a target number of cooling/heating cycles, which is a specification number of cycles to use an ignition coil, are 160 cycles. The result of the heating/cooling cycle test is shown in FIG. 6. In FIG. 6, horizontal axis represents the number of cooling/heating cycles. Both of the ignition coils according to the embodiment and the comparison example resists the cooling/heating cycle test of 300 cycles.

Therefore, another work pieces of the ignition coil according to the embodiment and the comparison example are prepared after the cooling/heating cycle test with 160 cycles. The work pieces are cut along the axial direction, and cross-sections of the work pieces are observed. According to the test, on the cross-sections near the edge of the primary spool disposed in the connector housing 63, a length of a crack in the ignition coil 1 according to the embodiment is shorter than that according to the comparison example. As a result, the life of the ignition coil 1 according to the embodiment can be made longer than that in the comparison example.

Next, the high-voltage generating test is performed by means of repeatedly generating high voltage in the secondary coil 40 of the ignition coil 1. In this test, the high voltage is 30 kv and is generated periodically. A frequency of the periodic high voltage, i.e., ignition frequency, is 100 Hz. A target time is set to 235 hours. The result of the high-voltage generating test is shown in FIG. 7. In FIG. 7, a horizontal axis represents a time in hour. The ignition coil 1 according to the embodiment resists the high-voltage generating test with 941 hours. After 941 hours, the generating voltage of the secondary coil 40 is reduced. The ignition coil in the comparison example resists the high-voltage generating test with 1500 hours. However, the ignition coil 1 according to the embodiment sufficiently resists to the high-voltage generating test with 235 hours that is a target time for using the ignition coil 1. Therefore, the ignition coil 1 according to the embodiment is substantially used with excellent insulating property.

Although the present invention has been fully described in connection with the preferred embodiment thereof with reference to the accompanying drawings, it is to be noted that various changes and modifications will become apparent to those skilled in the art.

For example, although the elastic part 50 and the rubber tube 52 are disposed in the center core portion 54 in the above embodiment, the elastic part 50 and the rubber tube 52 do not need to be disposed. Moreover, a magnet can be disposed in the center core portion 54, instead for the elastic part 50. Further, the outer core 20 does not need to be disposed.

In the present invention, it is possible that the secondary coil 40 generates high voltage electricity and the outer diameter of the secondary coil 40 is substantially small so that the ignition coil is inserted into the spark plug hole easily. In this case, for example, the diameter of a wire of the secondary winding 400 coated with the secondary coating 401 is set in a range between 40 μm and 90 μm, the outer diameter of the secondary coil 40 is set at 25 mm or below, and the secondary coil 40 is formed by winding the secondary winding 400 with 25000 turns or below. Therefore, a thin wire of the secondary winding 400 is wound, and the insulating resin 8 and the secondary coating 401 are more closely arranged. In this case, the thermal stress between the secondary coating 401 and the insulating resin 8 generally becomes larger. However, according to the present invention, the thermal stress can be effectively absorbed while the outer diameter of the secondary coil 40 can be made small.

Further, a broad radial portion can be formed on the peripheral of the casing 2. In this case, a large amount of the insulating resin can be filled in the broad radial portion. The broad radial portion is formed, for example, for accommodating a connector and an igniter. Generally, thermal stress may be concentrates in the insulating resin in the broad radial portion, and the broad radial portion may be applied with a large thermal stress. However, in the present invention, the thermal stress can be relieved, even when the broad radial portion is formed on the peripheral of the casing.

Such changes and modifications are to be understood as being within the scope of the present invention as defined by the appended claims.

What is claimed is:

1. An ignition coil, comprising:
an insulating resin;
a primary coil disposed in the insulating resin, the primary coil including a primary coating, and a primary wire coated with the primary coating; and
a secondary coil disposed in the insulating resin concentrically with the primary coil, the secondary coil including a secondary coating, and a secondary wire coated with the secondary coating,
wherein a glass transition temperature of the insulating resin is 130° C. or below.

2. An ignition coil according to claim 1, wherein the glass transition temperature of the insulating resin is in a range between 90° C. and 130° C.

3. An ignition coil according to claim 1, wherein the glass transition temperature of the insulating resin is in a range between 115° C. and 130° C.

4. An ignition coil according to claim 1, wherein the glass transition temperature of the insulating resin is in a range between 105° C. and 115° C.

5. An ignition coil according to claim 1, wherein the glass transition temperature of the insulating resin is in a range between 90° C. and 105° C.

6. An ignition coil according to claim 1, wherein a glass transition temperature of the secondary coating is 150° C. or above.

7. An ignition coil according to claim 1, wherein the glass transition temperature of the secondary coating is in a range between 150° C. and 210° C.

8. An ignition coil according to claim 2, wherein the glass transition temperature of the secondary coating is in a range between 150° C. and 210° C.

9. An ignition coil according to claim 3, wherein the glass transition temperature of the secondary coating is in a range between 150° C. and 210° C.

10. An ignition coil according to claim 4, wherein the glass transition temperature of the secondary coating is in a range between 150° C. and 210° C.

11. An ignition coil according to claim 5, wherein the glass transition temperature of the secondary coating is in a range between 150° C. and 210° C.

12. An ignition coil according to claim 1, wherein the glass transition temperature of the secondary coating is in a range between 150° C. and 170° C.

13. An ignition coil according to claim 3, wherein the glass transition temperature of the secondary coating is in a range between 150° C. and 170° C.

14. An ignition coil according to claim 4, wherein the glass transition temperature of the secondary coating is in a range between 150° C. and 170° C.

15. An ignition coil according to claim 5, wherein the glass transition temperature of the secondary coating is in a range between 150° C. and 170° C.

16. An ignition coil according to claim 1, wherein the glass transition temperature of the secondary coating is in a range between 170° C. and 190° C.

17. An ignition coil according to claim 3, wherein the glass transition temperature of the secondary coating is in a range between 170° C. and 190° C.

18. An ignition coil according to claim 4, wherein the glass transition temperature of the secondary coating is in a range between 170° C. and 190° C.

19. An ignition coil according to claim 5, wherein the glass transition temperature of the secondary coating is in a range between 170° C. and 190° C.

20. An ignition coil according to claim 1, wherein the glass transition temperature of the secondary coating is in a range between 190° C. and 210° C.

21. An ignition coil according to claim 3, wherein the glass transition temperature of the secondary coating is in a range between 190° C. and 210° C.

22. An ignition coil according to claim 4, wherein the glass transition temperature of the secondary coating is in a range between 190° C. and 210° C.

23. An ignition coil according to claim 5, wherein the glass transition temperature of the secondary coating is in a range between 190° C. and 210° C.

24. An ignition coil according to claim 1, wherein a diameter of the secondary wire is in a range between 40 μm and 90 μm, the secondary coil is formed by winding the secondary wire with 25000 or below, and an outer diameter of the secondary coil is 25 mm or below.

25. An ignition coil according to claim 1, further comprising:
a casing for accommodating the insulating resin, the primary coil and the secondary coil,
wherein the casing has a cylindrical shape, and is provided with a broad radial portion that is disposed at an end of the casing.

26. An ignition coil according to claim 1, wherein the insulating resin is composed of epoxy resin, and the secondary coating is made of polyurethane and polyimide.

27. An ignition coil used in an environment condition that is changed between a lowest temperature and a highest temperature, the ignition coil comprising:
an insulating resin;
a primary coil disposed in the insulating resin, the primary coil including a primary coating, and a primary wire coated with the primary coating; and
a secondary coil disposed in the insulating resin concentrically with the primary coil, the secondary coil including a secondary coating, and a secondary wire coated with the secondary coating,
wherein the insulating resin has a glass transition temperature that is lower than the highest temperature by a predetermined temperature, and is higher than the lowest temperature.

28. An ignition coil according to claim 27, wherein:
the glass transition temperature of the insulating resin is 130° C. or below; and
the glass transition temperature of the second coating is 150° C. or above.

29. An ignition coil according to claim 27, wherein the glass transition temperature of the second coating is set higher than the highest temperature.
